(19) United States
(12) Patent Application Publication
(10) Pub. No.: US 2007/0084018 A1
(43) Pub. Date: Apr. 19, 2007

(54) Tool device with a coupling unit for connecting detachably a tool and a handle of the same

(76) Inventor: Calvin Chou, Ta-Li City (TW)

Correspondence Address: MCNEES, WALLACE & NURICK LLC, 100 PINE STREET, P.O. BOX 1166, HARRISBURG, PA, 17108-1166, US

(21) Appl. No.: 11/320,124

(22) Filed: Dec. 28, 2005

(30) Foreign Application Priority Data
Oct. 19, 2005 (TW) 94218059

(51) Int. Cl. B25G 3/32

(52) U.S. Cl. 16/422

(57) ABSTRACT

A tool device includes a hollow handle, a tool, and a coupling unit. The coupling unit connects detachably the handle and the tool, and includes first and second coupling members, and a shank member. The first coupling member engages detachably the handle. The shank member is coupled to the first coupling member and extends into the handle. The second coupling member is coupled to the tool, is disposed in the handle, and engages detachably the shank member.

### BACKGROUND OF THE INVENTION

1. Field of the Invention

This invention relates to a tool device, more particularly to a tool device including a handle and a tool detachable from the handle.

2. Description of the Related Art

FIG. 1 illustrates a conventional woodworking tool device 1 that includes a wooden handle 12 and a tool 11. The handle 12 has an end portion 122 that is formed with an axial groove. The tool 11 has an end portion 111 that is fitted snugly into the axial groove in the end portion 122 of the handle 12.

The aforementioned conventional woodworking tool device 1 is disadvantageous in that when the tool 11 becomes unusable, the whole tool device 1 has to be discarded. Moreover, replacement of the tool 11 is not possible. Further, since the end portion 111 of the tool 11 is fitted snugly into the axial groove in the end portion 122 of the handle 12, the handle 12 can only be made from wood.

### SUMMARY OF THE INVENTION

Therefore, the object of the present invention is to provide a tool device that can overcome the aforesaid drawbacks of the prior art.

According to the present invention, a tool device comprises a hollow handle, a tool, and a coupling unit. The coupling unit connects detachably the handle and the tool, and includes first and second coupling members, and a shank member. The first coupling member engages detachably the handle. The shank member is coupled to the first coupling member and extends into the handle. The second coupling member is coupled to the tool, is disposed in the handle, and engages threadedly the shank member.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional tool device for woodworking;

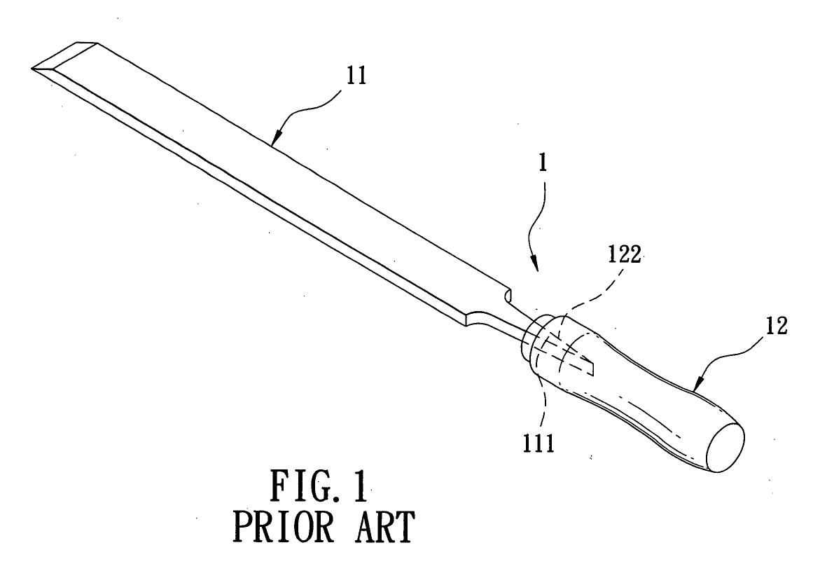

FIG. 2 is an exploded perspective view of the first preferred embodiment of a tool device according to the present invention;

FIG. 3 is an exploded partly sectional view of the first preferred embodiment;

FIG. 4 is a schematic partly sectional view to illustrate the first preferred embodiment in an assembled state;

FIG. 5 is a perspective view to illustrate the first preferred embodiment in an assembled state;

FIG. 6 is an exploded partly sectional view of the second preferred embodiment of a tool device according to the present invention; and

FIG. 7 is an exploded partly sectional view of the third preferred embodiment of a tool device according to the present invention.

### DETAILED DESCRIPTION OF THE PREFERRED EMBODIMENTS

Before the present invention is described in greater detail, it should be noted that like elements are denoted by the same reference numerals throughout the disclosure.

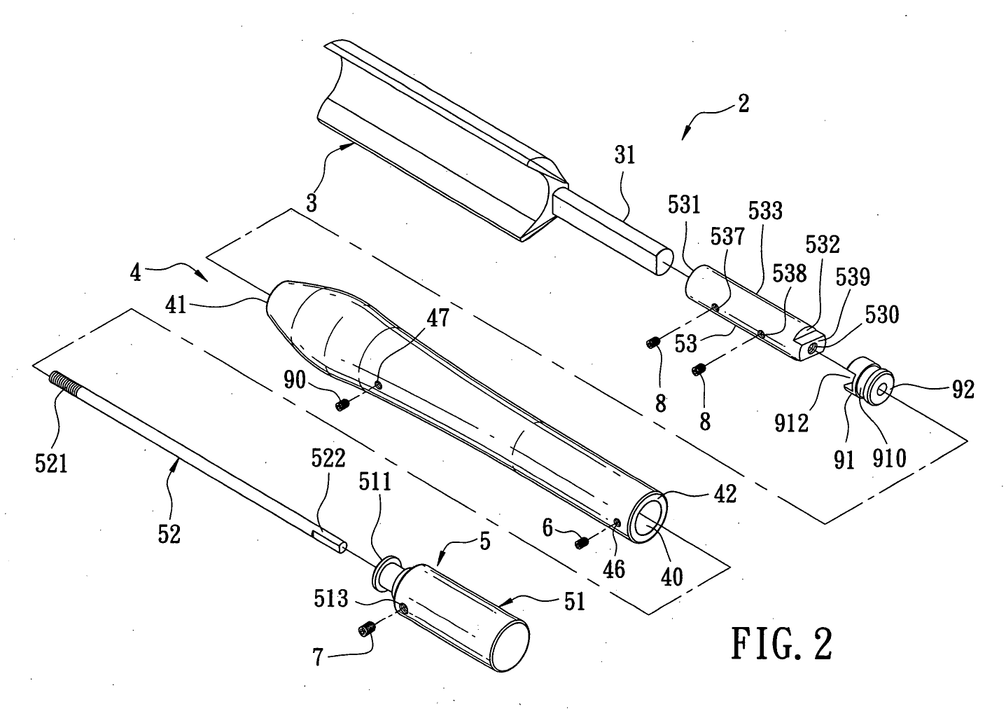

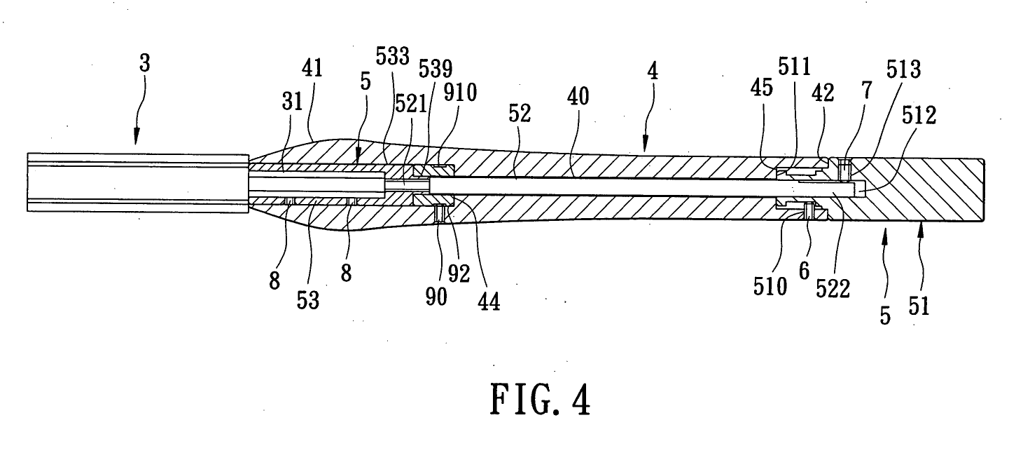

Referring to FIGS. 2 to 4, the first preferred embodiment of a tool device 2 for woodworking according to this invention is shown to include a hollow handle 4, a tool 3, and a coupling unit 5.

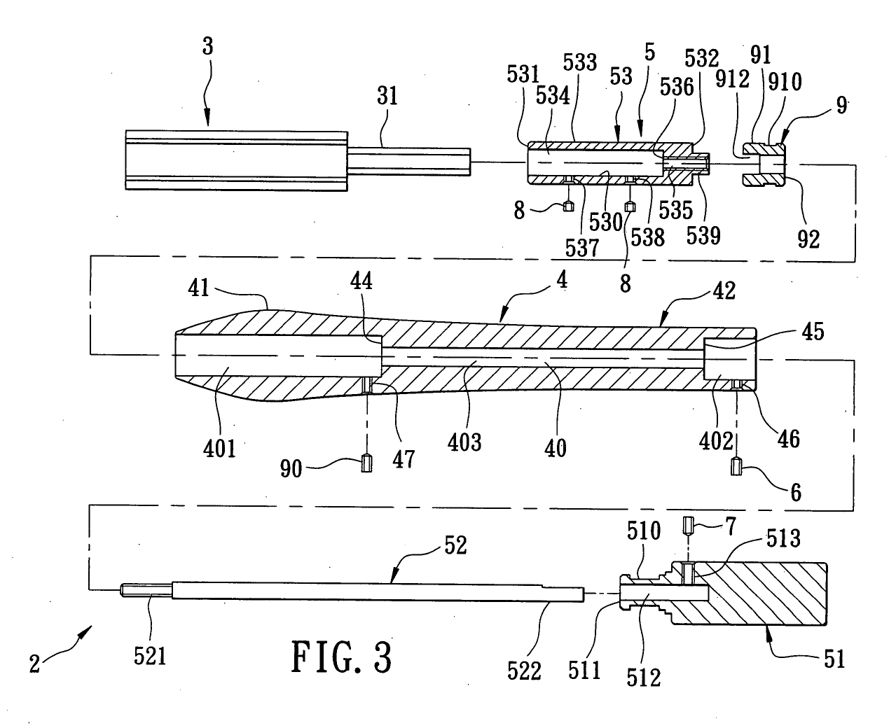

The handle 4 is tubular in shape, is formed with an axial hole 40 therethrough, and has opposite first and second end portions 41, 42. As best shown in FIG. 3, the axial hole 40 in the handle 4 has first and second hole sections 401, 402, and a middle hole section 403 that extends between the first and second hole sections 401, 402 of the axial hole 40 in the handle 4. It is noted that the middle hole section 403 of the axial hole 40 has a diameter that is smaller than that of the first and second hole sections 401, 402 of the axial hole 40 in the handle 4. Accordingly, the handle 4 is provided with a first shoulder 44 that is disposed between the first and middle hole sections 401, 403 of the axial hole 40 in the handle 4, and a second shoulder 45 that is disposed between the middle and second hole sections 403, 402 of the axial hole 40 in the handle 4.

The tool 3, such as a chisel or a knife, has an end portion 31 that is generally semi-circular in cross-section.

The coupling unit 5 serves to connect detachably the handle 4 and the tool 3, in a manner that will be described in greater detail hereinafter.

The coupling unit 5 includes first and second coupling members 51, 53, and a shank member 52. The first coupling member 51 of the coupling unit 5 engages detachably the second end portion 42 of the handle 4. In particular, the first coupling member 51 has an end portion 511 that is formed with an indentation 510, that extends into the second hole section 402 of the axial hole 40 in the handle 4, and that abuts against the second shoulder 45 of the handle 4. The second end portion 42 of the handle 4 is formed with a first radial hole 46 that is transverse to and that is in spatial communication with the second hole section 402 of the axial hole 40 in the handle 4. The coupling unit 5 further includes a first threaded piece 6 that threadedly engages the first radial hole 46 in the second end portion 42 of the handle 4 and that extends into the indentation 510 to abut against the end portion 511 of the first coupling member 51, thereby fastening the end portion 511 of the first coupling member 51 to the second end portion 42 of the handle 4.

The shank member 52 of the coupling unit 5 extends into the axial hole 40 in the handle 4 and is coupled releasably to the end portion 511 of the first coupling member 51. In particular, the shank member 52 has a first end portion 521, and a second end portion 522 that is opposite to the first end portion 521 of the shank member 52 and that has a generally semi-circular cross-section. The end portion 511 of the first coupling member 51 is further formed with an axial groove 512 that complements the cross-section of the second end portion 522 of the shank member 52, and a radial hole 513 that is transverse to and that is in spatial communication with the axial groove 512 in the end portion 511 of the first coupling member 51. The second end portion 522 of the shank member 52 extends into the axial groove 512 in the end portion 511 of the first coupling member 51. The coupling unit 51 further includes a second threaded piece 7 that threadedly engages the radial hole 513 in the end portion 511 of the first coupling member 51 and that abuts against the second end portion 522 of the shank member 52, thereby fastening the second end portion 522 of the shank member 52 to the end portion 511 of the first coupling member 51.

The second coupling member 53 of the coupling unit 5 is coupled releasably to the end portion 31 of the tool 3, is disposed in the first hole section 401 of the axial hole 40 in the handle 4, and engages threadedly the first end portion 521 of the shank member 52. In particular, the second coupling member 53 is tubular in shape, is formed with an axial hole 530 therein, and has opposite first and second end portions 531, 532, and a middle portion 533 that extends between the first and second portions 531, 532 of the second coupling member 53. As best shown in FIG. 3, the axial hole 530 in the second coupling member 53 has first and second hole sections 534, 535. It is noted that the first hole section 534 of the axial hole 530 in the second coupling member 53 has a diameter that is larger than that of the second hole section 535 of the axial hole 530 in the second coupling member 53. Accordingly, the second coupling member 53 is further formed with a shoulder 536 that is disposed between the first and second hole sections 534, 535 of the axial hole 530. The first hole section 534 of the axial hole 530 in the second coupling member 53 complements the cross-section of the end portion 31 of the tool 3. The end portion 31 of the tool 31 extends fittingly into the first hole section 534 of the axial hole 530 in the second coupling member 53, and abuts against the shoulder 536 of the second coupling member 53. The middle portion 533 of the second coupling member 53 is formed with a pair of radial holes 537, 538, each of which is transverse to and is in spatial communication with the first hole section 534 of the axial hole 530 in the second coupling member 53. The coupling unit 5 further includes third and fourth threaded pieces 8, each of which threadedly engages a respective one of the radial holes 537, 538 in the middle portion 533 of the second coupling member 53, and each of which abuts against the end portion 31 of the tool 3, thereby fastening the end portion 31 of the tool 3 to the first end portion 531 of the second coupling member 53. Furthermore, the first end portion 521 of the shank member 52 is formed with an outer thread that threadedly engages an inner thread in the second hole section 535 of the axial hole 530 in the second coupling member 53, thereby engaging the first end portion 521 of the shank member 52 and the second end portion 532 of the second coupling member 53.

The tool device 2 further includes a tubular limiting member 9 that serves to prevent rotation of the second coupling member 53 in the first hole section 401 of the axial hole 40 in the handle 4 during the threaded engagement (and disengagement) between the shank member 52 and the second coupling member 53. In this embodiment, the limiting member 9 has a first end portion 91 that engages detachably the second end portion 532 of the second coupling member 53, and a second end portion 92 that is opposite to the first end portion 91 of the limiting member 9 and that is coupled releasably to the first end portion 41 of the handle 4. In particular, the second end portion 532 of the second coupling member 53 is formed with an engaging protrusion 539 that has a generally rectangular shape. The first end portion 91 of the limiting member 9 is formed with an engaging groove 912 that complements the cross-section of the engaging protrusion 539 of the second coupling member 53. The engaging protrusion 539 of the second coupling member 53 extends fittingly into the engaging groove 912 of the limiting member 9, thereby resulting in engagement between the second end portion 532 of the second coupling member 53 and the first end portion 91 of the limiting member 9. Furthermore, the second end portion 92 of the limiting member 9 is formed with an annular indentation 910. The limiting member 9 is sleeved on the first end portion 521 of the shank member 52, and abuts against the first shoulder 44 of the handle 4. The first end portion 41 of the handle 4 is further formed with a second radial hole 47 that is transverse to and that is in spatial communication with the first hole section 401 of the axial hole 40 in the handle 4. The coupling unit 5 further includes a fifth threaded piece 90 that threadedly engages the second radial hole 47 in the first end portion 41 of the handle 4 and that extends into the indentation 910 to abut against the limiting member 9, thereby fastening the second end portion 92 of the limiting member 9 to the first end portion 41 of the handle 4.

In an alternative embodiment, the limiting member 9 may be dispensed with.

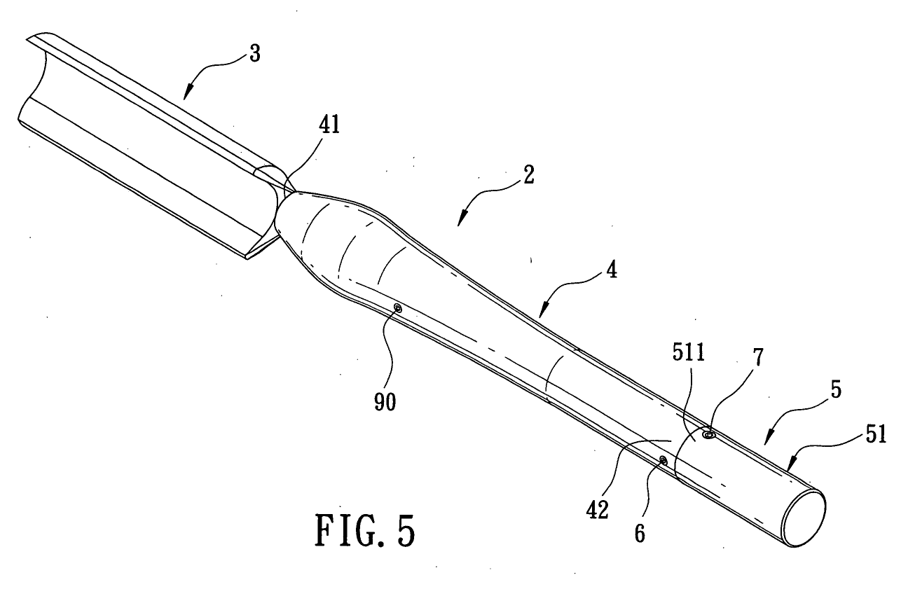

When assembling the tool device 2 of this invention, with further reference to FIG. 5, the second end portion 522 of the shank member 52 is first coupled to the end portion 511 of the first coupling member 51. The shank member 52 and the end portion 511 of the first coupling member 51 are then inserted into the axial hole 40 in the handle 4. Subsequently, the limiting member 9 is disposed in the first hole section 401 of the axial hole 40 in the handle 4, and is coupled to the first end portion 41 of the handle 4. The end portion 31 of the tool 3 is then inserted into the first hole section 534 of the axial hole 530 in the second coupling member 53, and is fastened to the middle portion 533 of the second coupling member 53 with the use of the third and fourth threaded pieces 8. Thereafter, the second coupling member 53 is then inserted into the first hole section 401 of the axial hole 40 in the handle 4 such that the second end portion 532 of the second coupling member 53 engages the first end portion 91 of the limiting member 9. The first coupling member 51 is then rotated so as to engage threadedly the first end portion 521 of the shank member 52 to the second end portion 532 of the second coupling member 53. Finally, the end portion 511 of the first coupling member 51 is fastened to the second end portion 42 of the handle 4 with the use of the second threaded piece 7.

When disassembling, the aforementioned procedure is performed in a reversed order.

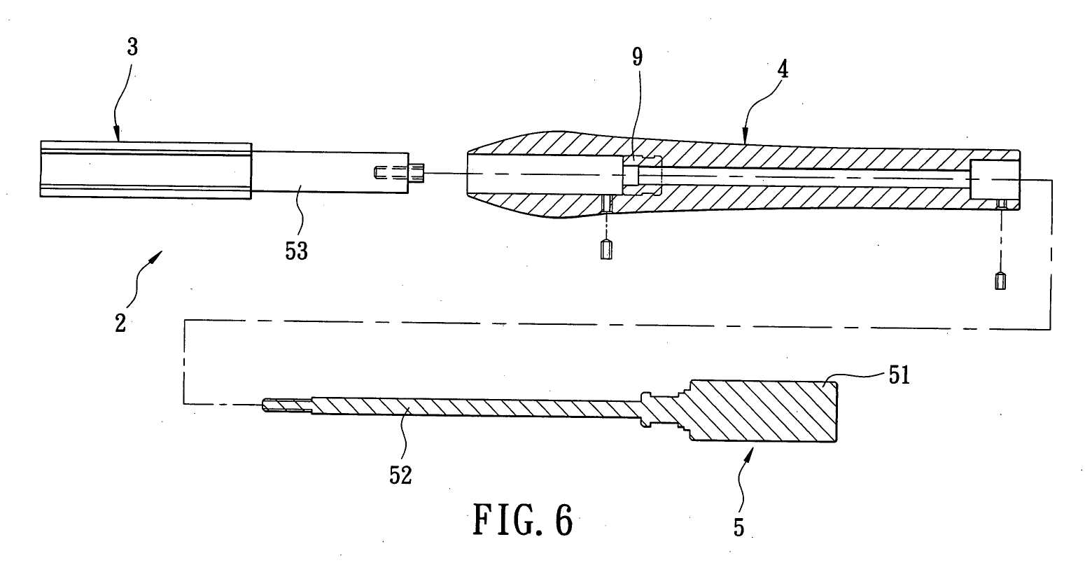

FIG. 6 illustrates the second preferred embodiment of a tool device 2 according to this invention. When compared to the previous embodiment, the shank member 52 and the first coupling member 51 are formed integrally. Moreover, the tool 3 and the second coupling member 53 are formed integrally. Further, the limiting member 9 and the handle 4 are formed integrally.

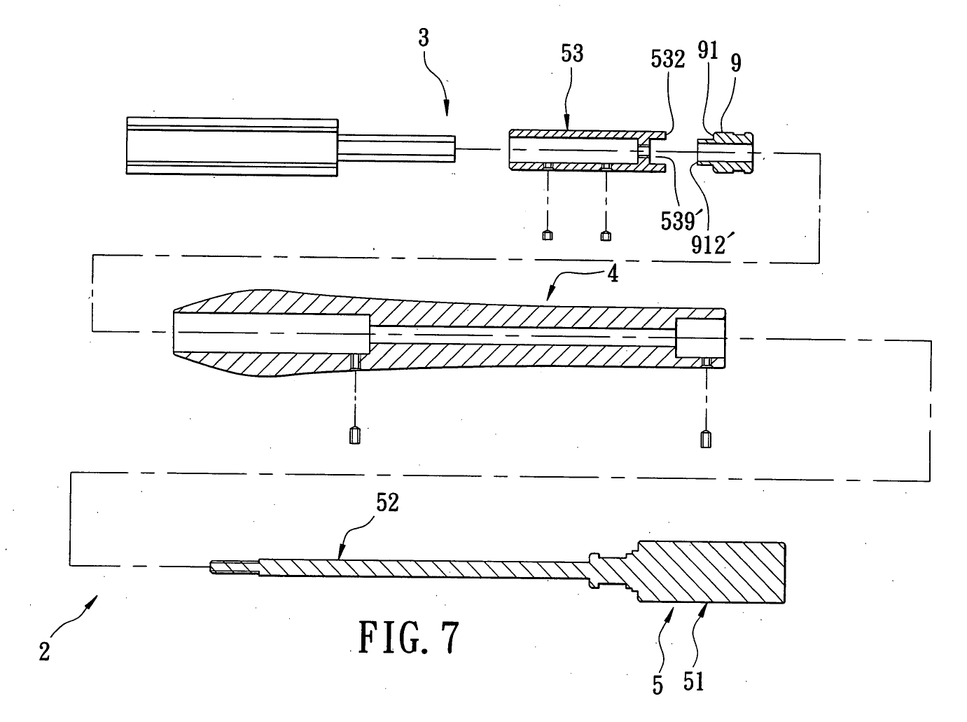

FIG. 7 illustrates the third preferred embodiment of a tool device 2 according to this invention. When compared to the previous embodiments, the first end portion 91 of the limiting member 9 is formed with the engaging protrusion 912′. The second end portion 532 of the second coupling member 53 is formed with the engaging groove 539′.

It has thus been shown that the tool device 2 of this invention includes a handle 4, a tool 3, and a coupling unit 5 that connects detachably the tool 3 to the handle 4. The construction as such permits replacement of the tool 3. Moreover, the handle 4 may be made from any other materials aside from wood.

While the present invention has been described in connection with what is considered the most practical and preferred embodiments, it is understood that this invention is not limited to the disclosed embodiments but is intended to cover various arrangements included within the spirit and scope of the broadest interpretation so as to encompassall such modifications and equivalent arrangements.

What is claimed is:

1. A tool device, comprising:
a hollow handle;
a tool; and
a coupling unit for connecting detachably said handle and said tool, said coupling unit including
a first coupling member that engages detachably said handle,
a shank member that is coupled to said first coupling member and that extends into said handle, and
a second coupling member that is coupled to said tool, that is disposed in said handle, and that engages threadedly said shank member.

2. The tool device as claimed in claim 1, wherein said coupling unit further includes a limiting member for preventing rotation of said second coupling member in said handle during the threaded engagement between said shank member and said second coupling member, said limiting member being disposed in and being coupled to said handle, and engaging detachably said second coupling member.

3. The tool device as claimed in claim 2, wherein one of said second coupling member and said limiting member is formed with an engaging protrusion, and the other one of said second coupling member and said limiting member is formed with an engaging groove, said engaging protrusion extending into said engaging groove so as to result in engagement between said second coupling member and said limiting member.

4. The tool device as claimed in claim 2, wherein said handle is tubular in shape, and is formed with an axial hole therein, and a radial hole that is transverse to and that is in spatial communication with said axial hole in said handle, said coupling unit further including a threaded piece that threadedly engages said radial hole in said handle and that abuts against said limiting member, thereby fastening said limiting member to said handle.

5. The tool device as claimed in claim 2, wherein said handle and said limiting member are formed integrally.

6. The tool device as claimed in claim 1, wherein said second coupling member is tubular in shape, and is formed with an axial hole therein, and a radial hole that is transverse to and that is in spatial communication with said axial hole in said second coupling member, said tool having an end portion that extends into said axial hole in said second coupling member, said coupling unit further including a threaded piece that threadedly engages said radial hole in said second coupling member and that abuts against said end portion of said tool, thereby fastening said end portion of said tool to said second coupling member.

7. The tool device as claimed in claim 1, wherein said tool and said second coupling member are formed integrally.

8. The tool device as claimed in claim 1, wherein said handle is tubular, and is formed with an axial hole therethrough, and a radial hole that is transverse to and that is in spatial communication with said axial hole in said handle, said first coupling member having an end portion that extends into said axial hole in said handle, said coupling unit further including a threaded piece that threadedly engages said radial hole in said handle and that abuts against said end portion of said first coupling member, thereby engaging said handle and said first coupling member.

9. The tool device as claimed in claim 1, wherein said first coupling member is formed with an axial groove, and a radial hole that is transverse to and that is in spatial communication with said axial groove in said first coupling member, said shank member having an end portion that extends into said axial groove in said first coupling member, said coupling unit further including a threaded piece that threadedly engages said radial hole in said first coupling member and that abuts against said end portion of said shank member, thereby engaging said first coupling member and said shank member.

10. The tool device as claimed in claim 1, wherein said first coupling member and said shank member are formed integrally.
